(19) United States
(12) Patent Application Publication
(10) Pub. No.: US 2026/0360817 A1
(43) Pub. Date: Nov. 12, 2026

(54) NON-AQUEOUS SECONDARY BATTERY

(71) Applicant: TOYOTA JIDOSHA KABUSHIKI KAISHA, Toyota-shi (JP)

(72) Inventor: Tsukasa YAMAGUCHI, Toyota-shi (JP)

(73) Assignee: TOYOTA JIDOSHA KABUSHIKI KAISHA, Toyota-shi (JP)

(21) Appl. No.: 19/546,619

(22) Filed: Feb. 23, 2026

(30) Foreign Application Priority Data
May 8, 2025 (JP) 2025-077733

(51) Int. Cl. H01M 10/0569; H01M 4/58; H01M 10/052; H01M 10/0567; H01M 10/0568

(52) U.S. Cl. CPC H01M 10/0569; H01M 4/5825; H01M 10/052; H01M 10/0567; H01M 10/0568; H01M 2300/0037

(57) ABSTRACT

A non-aqueous secondary battery including a positive electrode current collector foil, a positive electrode layer containing a positive electrode active material, an electrolyte layer containing a separator and a non-aqueous electrolyte solution, a negative electrode layer, and a negative electrode current collector foil, in which the positive electrode active material is lithium manganese iron phosphate (LMFP), a basis weight of the positive electrode layer is mg/cm² or more, the non-aqueous electrolyte solution contains lithium bis(fluorosulfonyl)imide (LiFSI) as a lithium salt, a dinitrile compound as an additive, and a cyclic carbonate compound and an ester compound as solvents, a concentration of the lithium salt in the non-aqueous electrolyte solution is 1.4 M or more, and the dinitrile compound is succinonitrile (SN).

### CROSS-REFERENCE TO RELATED APPLICATION

This application claims priority to Japanese Patent Application No. 2025-077733 filed on May 8, 2025. The disclosure of the above-identified application, including the specification, drawings, and claims, is incorporated by reference herein in its entirety.

### BACKGROUND

### 1. Technical Field

The present disclosure relates to a non-aqueous secondary battery.

### 2. Description of Related Art

Various techniques have been proposed for a non-aqueous secondary battery using a non-aqueous electrolyte solution as disclosed in WO 2023/219102 and Japanese Unexamined Patent Application Publication (Translation of PCT Application) No. 2016-536776 (JP 2016-536776 A).

### SUMMARY

In order to obtain the non-aqueous secondary battery having high battery characteristics, various non-aqueous electrolyte solutions have been proposed. The non-aqueous electrolyte solution contains, for example, an electrolyte such as a lithium salt, and a non-aqueous solvent.

Lithium bis(fluorosulfonyl)imide (LiFSI) as the lithium salt constituting the non-aqueous electrolyte solution has excellent lithium diffusibility, but corrosion of an Al foil that is a current collector foil is known.

In the non-aqueous secondary battery described in WO 2023/219102, a non-aqueous electrolyte solution obtained by mixing a cyclic carbonate compound and an ester compound is used. Meanwhile, when the ester compound decomposes, an acid is produced, and elution of Al from the current collector foil may be accelerated. In addition, when lithium manganese iron phosphate (LMFP) is used as a positive electrode active material, Mn or Fe may be eluted.

Elution of metal from the current collector foil or an active material causes a decrease in performance or a decrease in durability of the battery.

The present disclosure provides a non-aqueous secondary battery that can suppress metal elution from a current collector foil or an active material.

That is, the present disclosure includes the following aspects.

A non-aqueous secondary battery includes
a positive electrode current collector foil,
a positive electrode layer containing a positive electrode active material,
an electrolyte layer containing a separator and a non-aqueous electrolyte solution,
a negative electrode layer, and
a negative electrode current collector foil.

The positive electrode active material is lithium manganese iron phosphate (LMFP).

A basis weight of the positive electrode layer is 20 mg/cm² or more.

The non-aqueous electrolyte solution contains lithium bis(fluorosulfonyl)imide (LiFSI) as a lithium salt, a dinitrile compound as an additive, and a cyclic carbonate compound and an ester compound as a solvent.

A concentration of the lithium salt in the non-aqueous electrolyte solution is 1.4 M or more.

The dinitrile compound is succinonitrile (SN).

In the non-aqueous secondary battery according to the above aspect, a volume ratio of the cyclic carbonate compound to the ester compound may be 0.17 or more, the cyclic carbonate compound may be at least one of ethylene carbonate (EC) and propylene carbonate (PC), and
the ester compound may be at least one selected from the group consisting of methyl acetate (MA), methyl propionate (MP), ethyl acetate (EA), ethylene propionate (EP), and propyl propionate (PP).

In the non-aqueous secondary battery according to the above aspect, the non-aqueous electrolyte solution may further contain vinylene carbonate (VC) as the additive,
in the non-aqueous electrolyte solution, 1.0% by mass or more of the vinylene carbonate may be contained as the additive, and
in the non-aqueous electrolyte solution, 1.0% by mass or more of the dinitrile compound may be contained as the additive.

In the non-aqueous secondary battery according to the above aspect, the non-aqueous electrolyte solution may further contain LiX as the lithium salt, and the LiX may be at least one of LiPF₆ and LiBF₄.

In the non-aqueous secondary battery according to the above aspect, a concentration ratio (LiFSI/LiX) of the LiFSI to the LiX contained in the non-aqueous electrolyte solution may be 2.5 or more.

According to the present disclosure, it is possible to provide the non-aqueous secondary battery that can suppress the metal elution from the current collector foil or the active material.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a graph showing an aging-loss voltage of an embodiment and Comparative Examples;

FIG. 2 is a graph showing an initial capacity of the embodiment and Comparative Examples;

FIG. 3 is a graph showing a relationship between an elapsed time and a convergence current in a float test of the embodiment and Comparative Examples;

FIG. 4 is a graph showing a convergence-current cumulative value of the embodiment and Comparative Examples;

FIG. 5 is a graph showing an Al elution amount of the embodiment and Comparative Examples;

FIG. 6 is a graph showing an Fe elution amount of the embodiment and Comparative Examples; and

FIG. 7 is a graph showing an Mn elution amount of the embodiment and Comparative Examples.

### DETAILED DESCRIPTION OF EMBODIMENTS

Embodiments according to the present disclosure will be described below. It is noted that matters needed for implementing the present disclosure other than the matters particularly mentioned in the present specification (for example, a general configuration and a manufacturing process of a non-aqueous secondary battery that does not characterize the present disclosure) can be understood as design matters of those skilled in the art based on the related art in the field. The present disclosure can be carried out based on the contents disclosed in the present specification and the common general technical knowledge in the field.

In the present disclosure, the average particle diameter of particles is a median diameter (D50) which is a particle diameter at a cumulative value of 50% in a volume-based particle size distribution measured by a laser diffraction and scattering type particle size distribution measurement, unless otherwise specified.

The present disclosure provides a non-aqueous secondary battery including a positive electrode current collector foil, a positive electrode layer containing a positive electrode active material, an electrolyte layer containing a separator and a non-aqueous electrolyte solution, a negative electrode layer, and a negative electrode current collector foil, in which the positive electrode active material is lithium manganese iron phosphate (LMFP), a basis weight of the positive electrode layer is 20 mg/cm² or more,
the non-aqueous electrolyte solution contains lithium bis(fluorosulfonyl)imide (LiFSI) as a lithium salt, a dinitrile compound as an additive, and a cyclic carbonate compound and an ester compound as a solvent,
a concentration of the lithium salt in the non-aqueous electrolyte solution is 1.4 M or more, and
the dinitrile compound is succinonitrile (SN).

In the non-aqueous secondary battery according to the present disclosure, the use of a non-aqueous electrolyte solution in which LiFSI as the lithium salt, the specific dinitrile compound as the additive, and the cyclic carbonate compound and the ester compound as the solvent are combined successfully suppressed metal elution from the current collector foil and the active material. The non-aqueous secondary battery according to the present disclosure can suppress metal elution even though LiFSI that is known to elute an Al foil as a current collector foil is used, and exhibits excellent characteristics in which high lithium ion diffusibility and suppression of metal corrosion are both achieved.

Hereinafter, the electrolyte layer, the positive electrode current collector foil, the positive electrode layer, the negative electrode current collector foil, and the negative electrode layer constituting the non-aqueous secondary battery according to the present disclosure will be described in order. It is noted that the non-aqueous secondary battery according to the present disclosure has a structure in which a positive electrode including a positive electrode current collector foil and a positive electrode layer, the electrolyte layer, and a negative electrode including a negative electrode layer and a negative electrode current collector foil are laminated in this order, and the electrolyte layer is disposed between the positive electrode layer and the negative electrode layer.

### 1. Electrolyte Layer

The electrolyte layer is a layer containing a separator and a non-aqueous electrolyte solution.

The separator is impregnated with the non-aqueous electrolyte solution and prevents the positive electrode layer and the negative electrode layer from coming into contact with each other. The material of the separator is not particularly limited as long as it is a porous film, and examples thereof include resins such as polyethylene (PE), polypropylene (PP), polyester, polyvinyl alcohol, cellulose, and polyamide. In addition, the separator may have a single-layer structure or a multi-layer structure. Examples of the separator having a multi-layer structure include a separator having a two-layer structure of PE/PP, and a separator having a three-layer structure of PP/PE/PP or PE/PP/PE.

The separator may be a nonwoven fabric such as a resin nonwoven fabric and a glass fiber nonwoven fabric.

In the non-aqueous secondary battery according to the present disclosure, the non-aqueous electrolyte solution contains LiFSI as a lithium salt, a specific dinitrile compound as an additive, and a cyclic carbonate compound and an ester compound as a solvent.

The non-aqueous electrolyte solution contains LiFSI (chemical formula LiN(SO₂F)₂) as an indispensable component of a lithium salt. The non-aqueous electrolyte solution may contain solely LiFSI that is an imide salt as the lithium salt, or may contain other lithium salts other than LiFSI. Examples of the other lithium salts include imide salts such as lithium bis(trifluoromethanesulfonyl)imide (LiTFSI) and lithium bis(pentafluoroethylsulfonyl)imide (LiBETI). In addition, examples thereof also include organic lithium salts such as LiCF₃SO₃ and LiC(SO₂CF₃)₃. In addition, inorganic lithium salts (LiX) such as LiPF₆, LiBF₄, LiClO₄, and LiAsF₆ can also be used as the lithium salt. The other lithium salts may be at least one LiX of LiPF₆ and LiBF₄. In a non-aqueous secondary battery including LMFP as a positive electrode active material, LiPF₆ may accelerate elution of Mn or Fe from the LMFP, but in the non-aqueous secondary battery according to the present disclosure, elution of Mn and Fe can be suppressed even though LiPF₆ is used. The other lithium salts may be used alone or in combination of two or more kinds thereof.

The non-aqueous electrolyte solution may contain LiFSI as a main lithium salt. Here, the non-aqueous electrolyte solution containing LiFSI as the main lithium salt means that a concentration of LiFSI contained in the non-aqueous electrolyte solution is higher than a total concentration of other lithium salts contained in the non-aqueous electrolyte solution. For example, in a case where LiFSI and at least one LiX of LiPF₆ and LiBF₄ are used in combination as the lithium salt, a concentration ratio (LiFSI/LiX) of LiFSI to LiX contained in the non-aqueous electrolyte solution may be 2.5 or more. In addition, a concentration ratio (LiFSI/LiX) of LiFSI to LiX contained in the non-aqueous electrolyte solution may be 100.0 or less, or 10.0 or less.

A concentration of the lithium salt in the non-aqueous electrolyte solution is 1.4 M or more, and may be 2.0 M or more, 6.0 M or less, or 4.0 M or less. By setting the lithium salt concentration to 1.4 M or more, a non-aqueous electrolyte solution having excellent ion conductivity is obtained. In a case where the lithium salt concentration is high, the viscosity of the non-aqueous electrolyte solution is high, and the ion conductivity may be decreased. However, in the non-aqueous secondary battery according to the present disclosure, by combining the cyclic carbonate compound and the ester compound as the solvent, it is possible to suppress a decrease in ion conductivity.

The non-aqueous electrolyte solution according to the present disclosure contains succinonitrile (SN) which is a dinitrile compound. It is considered that, by containing succinonitrile, the non-aqueous electrolyte solution can suppress elution of a metal from the current collector foil or the positive electrode active material. It is presumed that this is due to a metal chelating effect of succinonitrile. In addition to succinonitrile, a dinitrile compound such as adiponitrile (AdN) can also be used, but in the non-aqueous secondary battery according to the present disclosure, succinonitrile is used as an indispensable dinitrile compound in consideration of battery performance other than the suppression of metal elution.

A content of succinonitrile which is a dinitrile compound is not particularly limited. In a case where a total mass of the non-aqueous electrolyte solution is set to 100%, the non-aqueous electrolyte solution may contain 1.0% by mass or more of succinonitrile, 5.0% by mass or less of succinonitrile, or 2.0% by mass or less of succinonitrile.

The non-aqueous electrolyte solution contains a cyclic carbonate compound and an ester compound as a solvent. The cyclic carbonate may be, for example, at least one of ethylene carbonate (EC) and propylene carbonate (PC), or may be ethylene carbonate (EC). In addition, the ester compound may be at least one selected from the group consisting of methyl acetate (MA), methyl propionate (MP), ethyl acetate (EA), ethylene propionate (EP), and propyl propionate (PP). In addition, the ester compound may be methyl propionate (MP).

A mixing ratio of the cyclic carbonate compound and the ester compound is not particularly limited. For example, a volume ratio (cyclic carbonate compound/ester compound) of the cyclic carbonate compound to the ester compound may be 0.17 or more. In addition, the volume ratio may be 9.00 or less, 6.00 or less, or 1.00 or less. In a case where the volume ratio of the cyclic carbonate compound to the ester compound is 0.17 or more, it is considered that the effect of suppressing metal elution by succinonitrile which is a dinitrile compound is increased.

The non-aqueous electrolyte solution may further contain vinylene carbonate (vinyl carbonic acid (VC)) as an additive. This is because, by containing vinylene carbonate, the formation of a film called a solid electrolyte interface (SEI) on the surface of the negative electrode is promoted. Since the SEI has an effect of protecting the negative electrode and suppressing the decomposition of the solvent, it is possible to stabilize the battery performance.

A content of vinylene carbonate in the non-aqueous electrolyte solution is not particularly limited, but in a case where a total mass of the non-aqueous electrolyte solution is set to 100%, the content of vinylene carbonate may be, for example, 1.0% by mass or more, 5.0% by mass or less, or 2.0% by mass or less.

The non-aqueous electrolyte solution may contain an ionic liquid. The ionic liquid may include, for example, at least one selected from the group consisting of a sulfonium salt, an ammonium salt, a pyridinium salt, a piperidinium salt, a pyrrolidinium salt, a morpholinium salt, a phosphonium salt, an imidazolium salt, and a derivative thereof.

### 2. Positive Electrode

The positive electrode includes a positive electrode current collector foil and a positive electrode layer containing a positive electrode active material.

Examples of the material of the positive electrode current collector foil include SUS, Cr, Au, Pt, Zn, aluminum, copper, nickel, iron, titanium, and carbon. A thickness of the positive electrode current collector foil is, for example, 0.1 μm or more and 100 μm or less. A planar shape of the positive electrode current collector foil is not particularly limited, and examples thereof include a circular shape, an elliptical shape, a rectangular shape, and any polygonal shape. The positive electrode current collector foil may have a configuration in which a buffer layer, an elastic layer, or a positive temperature coefficient (PTC) thermistor layer is disposed on a surface thereof.

The positive electrode layer contains lithium manganese iron phosphate (LMFP) as a positive electrode active material. The LMFP is usually in a particle shape, and an average particle diameter thereof may be, for example, 1 μm or more or 30 μm or less.

The positive electrode active material contained in the positive electrode layer may be solely the LMFP, or may be a combination of the LMFP and another positive electrode active material other than the LMFP, but may be solely the LMFP from the viewpoint of durability. As the other positive electrode active material, a known positive electrode active material of a lithium secondary battery can be used. Examples thereof include lithium metal composite oxides such as LiCoO₂, LiNiO₂, LiMnO₂, LiMn₂O₄, Li(NiCoMn)O₂, and Li(NiCoAl)O₂. Here, “(NiCoMn)” in “Li(NiCoMn)O₂” and “(NiCoAl)” in “Li(NiCoAl)O₂” indicate that the total of the composition ratio in the parentheses is 1, and the composition ratio of each element is optional as long as the total is 1. Li(NiCoMn)O₂ may be, for example, Li(Ni_{1/3}Co_{1/3}Mn_{1/3})O₂, Li(Ni_{0.5}Co_{0.2}Mn_{0.3})O₂, or Li(Ni_{0.8}Co_{0.1}Mn_{0.1})O₂. Li(NiCoAl)O₂ may be, for example, Li(Ni_{0.81}Co_{0.15}Al_{0.04})O₂.

In a case where a total mass of the positive electrode layer is set to 100%, a proportion of the positive electrode active material in the positive electrode layer is, for example, 20% by mass or more, and may be 30% by mass or more or 40% by mass or more, and may be 95% by mass or less or 70% by mass or less.

The positive electrode layer may contain at least one of a conductive material, a binder, a dispersant, and an electrolyte, as needed.

Examples of the conductive material include a carbon-based conductive material, metal particles, and a conductive polymer, and a carbon-based conductive material may be used.

Examples of the carbon-based conductive material include particle-shaped materials such as acetylene black (AB) and Ketjen black (KB), and fiber-shaped materials such as vapor-grown carbon fiber (VGCF), carbon nanotube (CNT), and carbon nanofiber (CNF).

In a case where a total mass of the positive electrode layer is set to 100%, a proportion of the conductive material in the positive electrode layer may be, for example, 0.1% by mass or more or 5% by mass or less.

Examples of the binder include styrene-butadiene rubber (SBR), polyimide (PI), polyacrylic acid (PAA), acrylonitrile-butadiene rubber (NBR), butadiene rubber (BR), polyvinylidene fluoride (PVdF), carboxymethyl cellulose (CMC), polytetrafluoroethylene (PTFE), a styrene-isoprene-styrene block copolymer (SIS), and an ethylene-propylene-diene copolymer (EPDM).

In a case where a total mass of the positive electrode layer is set to 100%, a proportion of the binder in the positive electrode layer may be, for example, 0.5% by mass or more or 15% by mass or less.

The dispersant is not particularly limited, and a known dispersant can be used. In a case where a total mass of the positive electrode layer is set to 100%, a proportion of the dispersant in the positive electrode layer may be, for example, 0.1% by mass or more or 1% by mass or less.

The electrolyte may be, for example, an inorganic solid electrolyte such as a sulfide solid electrolyte, a halide solid electrolyte, an oxide solid electrolyte, and a complex hydride solid electrolyte, or may be an organic solid electrolyte such as a gel electrolyte. A proportion of the solid electrolyte in the positive electrode layer may be, for example, 0% to 1% by mass.

A thickness of the positive electrode layer is, for example, 0.1 μm or more and 1000 μm or less, and may be 1 μm or more and 500 μm or less or 30 μm or more and 100 μm or less.

The positive electrode layer may be disposed on one surface of the positive electrode current collector foil, or may be disposed on both surfaces of the positive electrode current collector foil.

A method of manufacturing the positive electrode layer is not particularly limited. For example, the positive electrode layer can be provided on the positive electrode current collector foil by preparing a positive electrode slurry by mixing the LMFP, the conductive material, the binder, the dispersant, and a solvent, applying the positive electrode slurry to the positive electrode current collector foil, and drying the positive electrode slurry. A pressing treatment of pressing the positive electrode layer in a thickness direction may be performed. Examples of the pressing treatment include a roller press and a flat plate press. Examples of the solvent of the positive electrode slurry include N-methylpyrrolidone (NMP), tetralin, diisobutyl ketone, butyl butyrate, mesitylene, heptane, dibutyl ether, decane, dodecane, isodecane, and toluene. In addition, two or more components thereof may be contained.

It can be said that the non-aqueous secondary battery according to the present disclosure has a positive electrode layer having a basis weight of 20 mg/cm² or more that is a large basis weight. In a case where the basis weight of the positive electrode layer is large in this way, a side reaction other than a discharge reaction and a charge reaction is likely to proceed, the deterioration of the constituent material proceeds, and the battery performance is likely to decrease. However, in the non-aqueous secondary battery according to the present disclosure, it is possible to suppress the progress of the side reaction accompanied by the metal elution, and to stabilize the battery performance.

The basis weight of the positive electrode layer may be 20 mg/cm² or more, and may be, for example, 100 mg/cm² or less or 50 mg/cm² or less.

### 3. Negative Electrode

The negative electrode includes a negative electrode current collector foil and a negative electrode layer containing a negative electrode active material. Examples of the material of the negative electrode current collector foil include SUS, aluminum, copper, nickel, iron, titanium, and carbon. In addition, a thickness of the negative electrode current collector foil may be, for example, in a range of 1 μm to 50 μm. A planar shape of the negative electrode current collector foil is not particularly limited, and examples thereof include a circular shape, an elliptical shape, a rectangular shape, and any polygonal shape. The negative electrode current collector foil may have a configuration in which a buffer layer, an elastic layer, or a PTC thermistor layer is disposed on a surface thereof.

The negative electrode layer is a layer containing at least the negative electrode active material. In addition, the negative electrode layer may contain at least one of a conductive material, a binder, and an electrolyte, as needed.

The negative electrode active material may be, for example, in a particle shape or a sheet shape. An average particle diameter of the particles of the negative electrode active material may be, for example, 1 μm or more. An average particle diameter of the negative electrode active material may be, for example, 30 μm or less.

The negative electrode active material may include, for example, at least one selected from the group including a carbon-based active material, an Li-based active material, an Si-based active material, a Si—C composite material, and lithium titanate. The carbon-based active material may include, for example, at least one selected from the group including graphite, soft carbon, and hard carbon. The term “graphite” is a general term for natural graphite and artificial graphite. Examples of the Li-based active material include Li, lithium silicate, and an Li alloy. Examples of the Si-based active material include Si, SiO, and an Si alloy. The Si—C composite material indicates a composite material of a carbon-based active material (graphite or the like) and an Si-based active material (Si or the like).

Examples of the conductive material, the binder, and the electrolyte used in the negative electrode layer include the same materials as those described in “2. Positive Electrode” above. In addition, the negative electrode layer may contain a dispersant.

The negative electrode layer may be disposed on one surface of the negative electrode current collector foil, or may be disposed on both surfaces of the negative electrode current collector foil. A method of manufacturing the negative electrode layer is not particularly limited. For example, the negative electrode layer can be provided on the negative electrode current collector foil by preparing a negative electrode slurry by mixing the negative electrode active material, the conductive material, the binder, and water (solvent), applying the negative electrode slurry to the negative electrode current collector foil, and drying the negative electrode slurry.

A basis weight of the negative electrode layer is not particularly limited, and may be, for example, 8.0 mg/cm² or more, 8.9 mg/cm² or more, 100.0 mg/cm² or less, or 50.0 mg/cm² or less.

### 4. Non-Aqueous Secondary Battery

The type of the non-aqueous secondary battery according to the present disclosure is not particularly limited, but is typically a lithium ion battery. A shape of the battery is not particularly limited, and may be, for example, a coin type, a cylindrical type, a square type, a sheet type, a button type, a flat type, or a laminated type. In a case of a battery stack in which a plurality of batteries is laminated, the battery stack may be a monopolar type or a bipolar type.

Examples of an application of the battery include a power source of a vehicle such as a hybrid electric vehicle (HEV), a plug-in hybrid electric vehicle (PHEV), a battery electric vehicle (BEV), a gasoline vehicle, and a diesel vehicle. In particular, the battery may be used as a power source for driving a hybrid electric vehicle (HEV), a plug-in hybrid electric vehicle (PHEV), or a battery electric vehicle (BEV). The battery may be used as a power source of a moving body other than a vehicle (for example, a train, a ship, or an airplane), or may be used as a power source of an electrical product, such as an information processing device.

### Embodiment 1

### Preparation of Non-Aqueous Electrolyte Solution

Each component of the non-aqueous electrolyte solution shown in Table 1 was prepared. That is, LiFSI (imide salt) was prepared as the lithium salt. LiFSI was weighed such that the LiFSI concentration in the non-aqueous electrolyte solution was 1.4 M.

In addition, EC (cyclic carbonate compound) and MP (ester compound) were prepared as the solvent. Each of EC and MP was weighed such that, in a case where the total volume of EC and MP was set to 100%, EC was 15% and MP was 85%. In this case, a volume ratio (A/B) of the cyclic carbonate compound (here, A) to the ester compound (here, B) was 0.176.

In addition, SN (dinitrile compound) and VC were prepared as the additives. Each of SN and VC was weighed such that, in a case where the total mass of the non-aqueous electrolyte solution was set to 100%, each of SN and VC was 1.0% by mass.

The above-described components were mixed to prepare a non-aqueous electrolyte solution.

TABLE 1

| | | Non-aqueous electrolyte solution | | | | | | | | | | | | |
|---|---|---|---|---|---|---|---|---|---|---|---|---|---|---|
| | | | | | | | Solvent | | | | | Addictive | | |
| | | | | | | | Cyclic | | Ester | | | | Dinitrile | |
| | | | | | | | carbonate | | com- | | | VC | compound | |
| | Positive | Lithium salt | | | | | compound | | pound | | | Addi- | Addi- | |
| | electrode | Imide salt | | LiX | | | Vol- | | tion | | | tion | | |
| | active | Concen- | | Concen- | | | ume | | ume | | | amount | amount | |
| | | tration | | tration | | LiFSI/ | ratio | | ratio | | | % by | % by | |
| | material | M | Type | M | Type | LiX | % | Type | % | Type | A/B | mass | mass | Type |
| Comparative | LMFP | 1.0 | LiFSI | — | — | | 15 | EC | 85 | MP | 0.176 | 1.0 | — | — |
| Example 1 | | | | | | | | | | | | | | |
| Comparative | LMFP | 1.4 | LiFSI | 0.4 | LiPF₆ | 2.5 | 15 | EC | 85 | MP | 0.176 | 1.0 | — | — |
| Example 2 | | | | | | | | | | | | | | |
| Embodiment | LMFP | 1.4 | LiFSI | — | — | | 15 | EC | 85 | MP | 0.176 | 1.0 | 1.0 | SN |
| 1 | | | | | | | | | | | | | | |

### Production of Cell (Non-Aqueous Secondary Battery)

LMFP (positive electrode active material), CNT (conductive material), PVdF (binder), and a dispersant were prepared, and were dispersed in NMP such that the mass ratio of LMFP:CNT:PVdF:dispersant was 94.32%:1.40%:4.00%:0.28%, thereby preparing a positive electrode slurry. The positive electrode slurry was applied onto an Al foil (positive electrode current collector foil) such that the basis weight was 20 mg/cm², and dried to produce a positive electrode in which a positive electrode layer was provided on the positive electrode current collector foil.

On the other hand, artificial graphite (negative electrode active material), CNT (conductive material), CMC (binder), and SBR (binder) were prepared, and were dispersed in water such that the mass ratio of artificial graphite:CNT:CMC:SBR was 97.170%:0.125%:0.405%:2.300%, thereby preparing a negative electrode slurry. The negative electrode slurry was applied onto a Cu foil (negative electrode current collector foil) such that the basis weight was 8.9 mg/cm², and dried to produce a negative electrode in which a negative electrode layer was provided on the negative electrode current collector foil.

Next, an Al tab was ultrasonically welded to the positive electrode, and a Ni tab was ultrasonically welded to the negative electrode. Subsequently, a laminate in which a separator was interposed between the positive electrode and the negative electrode was produced. The laminate was packed into a laminated exterior body and dried at 80 °C.

The non-aqueous electrolyte solution prepared as described above was charged into the laminated exterior body in a glove box, and the laminated exterior body was sealed with a heat sealer to produce a cell (non-aqueous secondary battery).

### Comparative Example 1

As shown in Table 1, the non-aqueous electrolyte solution was prepared and a cell was produced in the same manner as in Embodiment 1, except that SN (dinitrile compound) was not used.

### Comparative Example 2

As shown in Table 1, the non-aqueous electrolyte solution was prepared and a cell was produced in the same manner as in Embodiment 1, except that LiFSI (imide salt) and LiPF₆ were used as the lithium salt and SN (dinitrile compound) was not used. It is noted that the non-aqueous electrolyte solution was prepared such that the LiFSI concentration was 1.0 M and the LiPF₆ concentration was 0.4 M. In this case, a concentration ratio (LiFSI/LiX) of LiFSI to LiX was 2.5.

### Evaluation of Cell

The cells produced in Embodiment 1 and Comparative Examples 1 and 2 as described above were evaluated as follows. The results are shown in Table 2.

### Initial Conditioning

The following treatment was performed as initial conditioning. That is, first, the cell was CC-charged at 0.05 C to 4.3 V at 25 °C. Next, the cell was allowed to stand at 60 °C for 20 hours. Thereafter, the cell was CCCV-charged at 0.1 C to 4.3 V at 25 °C, and CC-discharged at 0.2 C to 2.5 V.

### Evaluation of Aging-Loss Voltage

The voltage was measured before and after the standing treatment (60 °C, 20 hours) of the above-described initial conditioning, and the voltage difference before and after the standing treatment was calculated from the following expression.

(Aging-loss voltage)=(voltage before standing treatment)−(voltage after standing treatment)

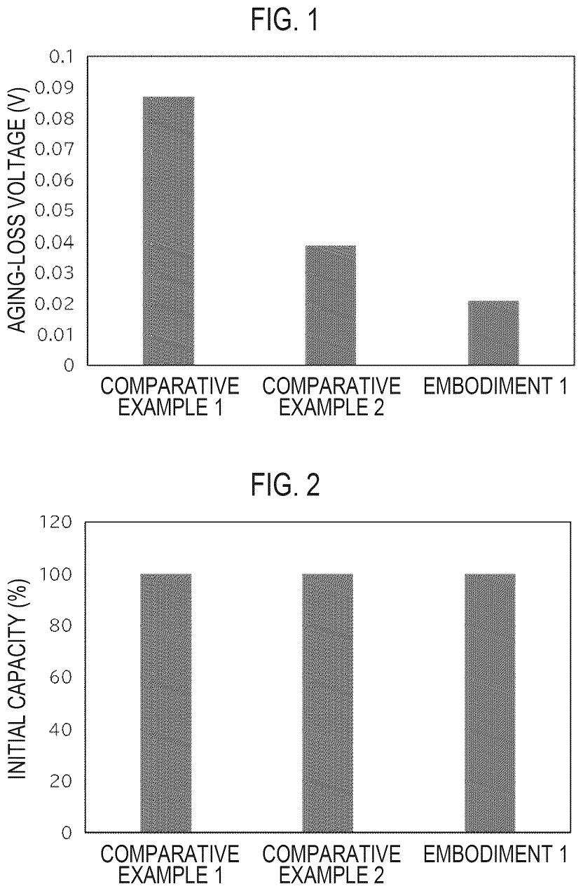

FIG. 1 is a graph showing an aging-loss voltage of the embodiment and Comparative Examples.

### Evaluation of Initial Discharge Capacity

The discharge capacity of the cell subjected to the initial conditioning was measured as follows. That is, the cell was CCCV-charged at 0.1 C to 4.3 V at 25 °C, and CC-discharged at 0.1 C to 2.5 V, and the discharge capacity was measured. The initial capacity of Comparative Example 1 was set as a reference (100%), and the initial capacities of Embodiment 1 and Comparative Example 2 were standardized. FIG. 2 is a graph showing the initial capacity of the embodiment and Comparative Examples.

### Float Test

The cell subjected to the initial conditioning was subjected to a float test of maintaining 4.3 V by CV charging with an external power supply at 60 °C for 1 week. During the float test, the current value of the cell was measured.

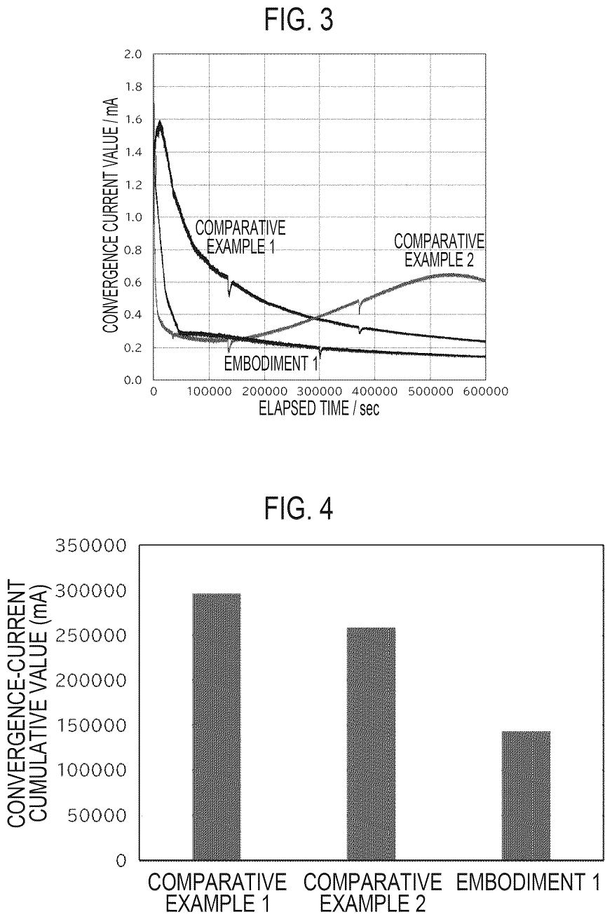

FIG. 3 is a graph showing a relationship between an elapsed time and a convergence current (mA) in the float test of the embodiment and Comparative Examples. It is noted that FIG. 3 shows the results from the start of the float test to 600,000 seconds later.

In addition, the measured convergence current values during the float test were integrated. FIG. 4 is a graph showing a convergence-current cumulative value (mA) of the embodiment and Comparative Examples.

### Evaluation of Metal Elution Amount

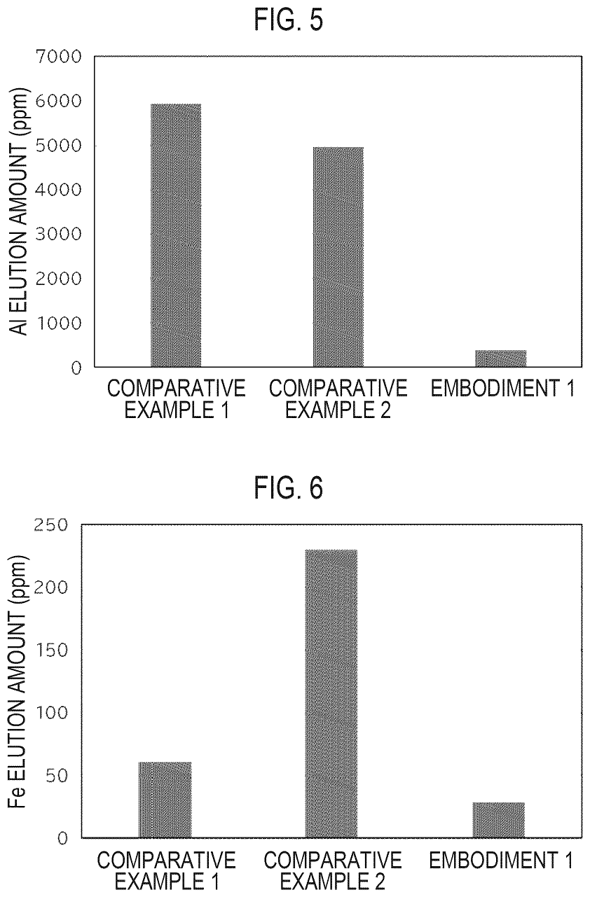

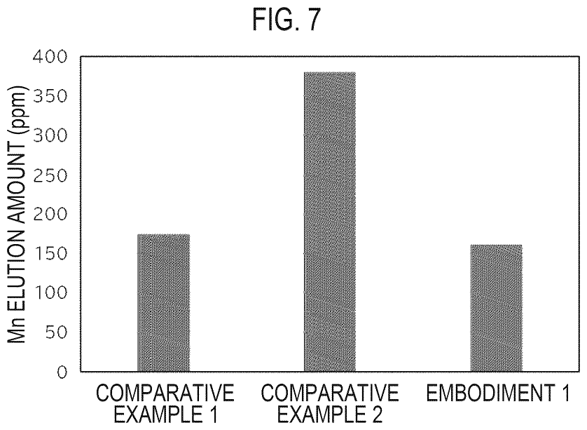

The metal (Al, Fe, and Mn) elution amount of the cell subjected to the float test was measured as follows. That is, the cell after the float test was disassembled, and first, solely the negative electrode layer was taken out and weighed. Next, the taken-out negative electrode layer was heated together with hydrochloric acid and nitric acid. After the heating, the metal concentration of the filtrate was analyzed by ICP. FIG. 5 is a graph showing an Al elution amount of the embodiment and Comparative Examples. FIG. 6 is a graph showing an Fe elution amount of the embodiment and Comparative Examples. FIG. 7 is a graph showing an Mn elution amount of the embodiment and Comparative Examples.

TABLE 2

| | | | Convergence- | | | |
|---|---|---|---|---|---|---|
| | Aging- | | current | Al | Fe | Mn |
| | loss | Initial | cumulative | elution | elution | elution |
| | voltage | capacity | value | amount | amount | amount |
| | V | % | mA | ppm | ppm | ppm |
| Comparative | 0.087 | 100 | 296165 | 5923 | 61 | 174 |
| Example 1 | | | | | | |
| Comparative | 0.039 | 100 | 258905 | 4966 | 230 | 380 |
| Example 2 | | | | | | |
| Embodiment | 0.041 | 100 | 143326 | 386 | 29 | 161 |
| 1 | | | | | | |

As shown in Table 2 and FIG. 1, the cell (non-aqueous secondary battery) of Embodiment 1 had a lower aging-loss voltage than those of Comparative Examples 1 and 2. In particular, in a case where the cells of Embodiment 1 and Comparative Example 1 that are different solely in whether to contain succinonitrile were compared, the aging-loss voltage of Embodiment 1 was about ¼ of that of Comparative Example 1. It is considered that the reason why the aging-loss voltage of the cell of Embodiment 1 was low was that the side reaction did not proceed in the cell of Embodiment 1 in the standing treatment of the initial conditioning.

On the other hand, as shown in Table 2 and FIG. 2, Embodiment 1 exhibited the same initial capacity as Comparative Examples 1 and 2.

In addition, as shown in Table 2 and FIG. 4, the cell of Embodiment 1 had a significantly smaller convergence-current cumulative value than those of Comparative Examples 1 and 2. In the comparison between Comparative Example 1 and Embodiment 1, the convergence-current cumulative value of Embodiment 1 was ½ of that of Comparative Example 1. This means that, in the cell of Embodiment 1, the discharge due to the side reaction during the float test was smaller than that in the cells of Comparative Examples 1 and 2. That is, it can be said that the cell of Embodiment 1 is unlikely to cause a side reaction even in a severe environment of 60 °C.

In addition, as shown in Table 2 and FIGS. 5 to 7, the cell of Embodiment 1 had a smaller metal elution amount than those of the cells of Comparative Examples 1 and 2 in any of Al, Fe, and Mn. In particular, from the comparison with Comparative Example 1, it was found that Embodiment 1 had a particularly high effect of suppressing the elution amount of Al. Al is derived from the positive electrode current collector foil, and Fe and Mn are derived from the positive electrode active material, and it is considered that the Al, Fe, and Mn eluted from the positive electrode were precipitated in the negative electrode layer, respectively. The evaluations of the metal elution amount from FIGS. 5 to 7, and the results of the aging-loss voltage of FIG. 1 and the convergence-current cumulative value of FIG. 4 are considered together. It can be said that the cell of Embodiment 1 suppresses the side reaction, particularly, the metal elution from the current collector foil and the active material in the positive electrode, even in a severe environment of 60 °C.

It is noted that, as shown in FIGS. 6 and 7, the cell of Comparative Example 2 had a very large Fe elution amount and Mn elution amount as compared with the cells of Comparative Example 1 and Embodiment 1. It is considered that this is because, in the cell of Comparative Example 2, LiPF₆ was also used as the lithium salt in addition to LiFSI. In the time change of the convergence current shown in FIG. 3, Comparative Example 2 exhibited a behavior different from that of Embodiment 1 and Comparative Example 1, and it is considered that the side reaction accompanied by the elution of Mn and Fe proceeded as compared with Embodiment 1 and Comparative Example 1.

What is claimed is:

1. A non-aqueous secondary battery comprising:
a positive electrode current collector foil;
a positive electrode layer containing a positive electrode active material;
an electrolyte layer containing a separator and a non-aqueous electrolyte solution;
a negative electrode layer; and
a negative electrode current collector foil, wherein:
the positive electrode active material is lithium manganese iron phosphate (LMFP);
a basis weight of the positive electrode layer is 20 mg/cm² or more;
the non-aqueous electrolyte solution contains lithium bis(fluorosulfonyl)imide (LiFSI) as a lithium salt, a dinitrile compound as an additive, and a cyclic carbonate compound and an ester compound as a solvent;
a concentration of the lithium salt in the non-aqueous electrolyte solution is 1.4 M or more; and
the dinitrile compound is succinonitrile (SN).

2. The non-aqueous secondary battery according to claim 1, wherein:
a volume ratio of the cyclic carbonate compound to the ester compound is 0.17 or more;
the cyclic carbonate compound is at least one of ethylene carbonate (EC) and propylene carbonate (PC); and
the ester compound is at least one selected from the group consisting of methyl acetate (MA), methyl propionate (MP), ethyl acetate (EA), ethylene propionate (EP), and propyl propionate (PP).

3. The non-aqueous secondary battery according to claim 1, wherein:
the non-aqueous electrolyte solution further contains vinylene carbonate (VC) as the additive;
in the non-aqueous electrolyte solution, 1.0% by mass or more of the vinylene carbonate is contained as the additive; and
in the non-aqueous electrolyte solution, 1.0% by mass or more of the dinitrile compound is contained as the additive.

4. The non-aqueous secondary battery according to claim 1, wherein:
the non-aqueous electrolyte solution further contains LiX as the lithium salt; and
the LiX is at least one of LiPF₆ and LiBF₄.

5. The non-aqueous secondary battery according to claim 4, wherein a concentration ratio (LiFSI/LiX) of the LiFSI to the LiX contained in the non-aqueous electrolyte solution is 2.5 or more.
